(19) United States
(12) Patent Application Publication
(10) Pub. No.: US 2005/0230363 A1
(43) Pub. Date: Oct. 20, 2005

(54) Device for processing work pieces with height offset

(76) Inventors: Sascha Debuan, Stuttgart (DE); Klaus Goth, Sindelfingen (DE); Vladan Todorovic, Reutlingen (DE)

Correspondence Address: PENDORF & CUTLIFF, 5111 MEMORIAL HIGHWAY, TAMPA, FL, 33634-7356, US

(21) Appl. No.: 11/037,415

(22) Filed: Jan. 18, 2005

(30) Foreign Application Priority Data
Jan. 16, 2004 (DE) 10 2004 002 589.4
Mar. 4, 2004 (DE) 10 2004 010 483.2

(51) Int. Cl. B23K 26/20

(52) U.S. Cl. 219/121.63; 219/121.78; 219/161

(57) ABSTRACT

The invention concerns a device for processing workpieces with height offset. It is the task of the invention to develop a device in which the flexibility of the positioning of a clamping tool is improved and the number of necessary application movements of the clamping tool is reduced. The invention is comprised therein, that a device for processing of workpieces with height offset, with a tool securable to a processing head, which in a work area is directed onto at least one workpiece, with a clamp head with a clamp tool for fixing the workpiece in a desired position in the environment of the work area, and with an actuating element for the clamping tool, the clamping tool (10) is adapted to the height (z) of the height offset.

### BACKGROUND OF THE INVENTION

1. Field of the invention

The invention concerns a device for processing workpieces with height offset according to the precharacterizing portion of claim 1.

2. Related Art of the Invention

When joining by a process that does not involve a direct application of force at the joining location, such as by laser beam welding, electron beam welding or plasma welding, it is still necessary that the gap between the two members being joined does not exceed a maximal process- and material-dependent value. This is of particular significance in the overlap-welding of vehicle body panels. For this reason the sheets must remain clamped, as a rule, in the immediate vicinity of the welding site. This is associated with a large expenditure of time per cycle in the movement of the clamps and/or the welding head, above all during relocation of the clamps and in the case of constructional elements with a height offset (non-planar) In the case that the clamps are moved, then the clamp rolls or clamp fingers are conventionally moved along the workpiece with the same speed as the welding head. Thereby an acceptable gap width is maintained in the environment of the welding site. The clamping occurs respectively at the same height (on the same plane) as the welding process. In the case of work pieces with height offset, the clamping elements must be lifted off and again seated thereupon. This reduces the achievable joining speed. Further yet, the variations of workpiece geometry that come into consideration, for example, workpieces exhibiting a reinforcing corrugation, are limited by the mechanics of the pressing element. Due to the necessity of moving with the clamping element into a lower lying clamping location, the maximal weld joint or seam length is reduced in the area occupied by the interfering contour of the clamping element.

In the welding device shown in DE 44 26 719 A1, clamping devices are used on planar workpieces for freely accessible welding sites, which clamping devices are rigidly connected to a welding head. For limitedly accessible welding sites, a welding head is secured to an end of a programmable robot arm. The welding head is therewith positionable independently and freely between multiple clamping elements. The clamping elements have an opening through which a laser beam acts. Therewith, a clamping round about the welding site is possible.

### SUMMARY OF THE INVENTION

It is the task of the invention to develop a device for processing workpieces with height offset, in which the flexibility of the positioning of the clamping tool is improved and the number of necessary application or seating movements of the clamping tool is reduced.

The task is solved by a device having the characteristics of claim 1. Advantageous embodiments can be steen in the dependent claims.

The term “processing” should be understood in the sense of the present invention to mean, in particular, processes of joining technology, such as welding or adhering, processes of surface treatment, such as coating or application, and finishing processes, such as cutting or thermal treatment. The invention is particularly advantageous in laser welding, in particular in the case of scanner based laser welding, of body panels.

The invention is comprised in that a clamping element is employed which is adapted to, or is automatically adaptable to, the height offset of a workpiece. The invention is in particular employable in the case of laser welding devices in which the laser head as well as the clamping head are provided at the end of a robot arm. The introduction of force on the workpiece occurs at defined application points, lines or surfaces. Due to the height offset in a workpiece, the contact positions of the clamping element and the position of the work plane of the processing head may be at different levels. The force transmission from the contact position of the clamp element in the clamping direction of the workpiece occurs via the workpiece itself. The height difference between the contact position and processing position can be adjustable.

When using the device to join two workpieces, the joining position of the processing head and the contact position of the clamping tool can be offset in the height direction relative to each other. Thereby an automatic height adaptation is achieved, wherein even planar areas can be joined with the clamp device.

Since the clamping tool is adaptable in the height offset, a high flexibility and cost saving is achieved when employed in a movable clamping technique. This applies in particular when workpieces are being produced with variations. With the present invention it is no longer necessary to dive or penetrate with the clamping device for example into reinforcing corrugations and other workpiece recesses. Thus, a great range of options is opened with regard to the possibility of the geometric design of the workpieces. For example, a workpiece can be designed with a narrow reinforcing corrugation; in certain cases, with a given recess breadth, a greater joining length and therewith a higher stability or stiffness can be achieved. With the invention the number of required mounting or application movements is reduced, whereby a wearing of the clamping tool is reduced and the processing time is reduced.

The invention is particularly advantageous for use in welding automobile body floors with reinforcing corrugations in the floor sheet metal. Therein one can work with smooth processing speed with a low number of seating movements of the clamping tool, as a result of which cycle time and cost advantages are produced.

### BRIEF DESCRIPTION OF THE DRAWINGS

The invention will be described in greater detail in the following on the basis of an illustrative embodiment, wherein there is shown:

FIG. 1 a schematic of a welding device with a moved clamping head,

FIG. 2 a schematic of a clamping tool with point-shaped clamping force input,

FIG. 3 a schematic of a clamping tool with linear-shaped clamping force input,

FIG. 4 a schematic of a clamping tool with planar-shaped clamping force input,

FIG. 5 a schematic of a clamping tool with yielding clamping element, and

FIG. 6 a schematic of a clamping tool with a movable clamping element.

### DETAILED DESCRIPTION OF THE INVENTION

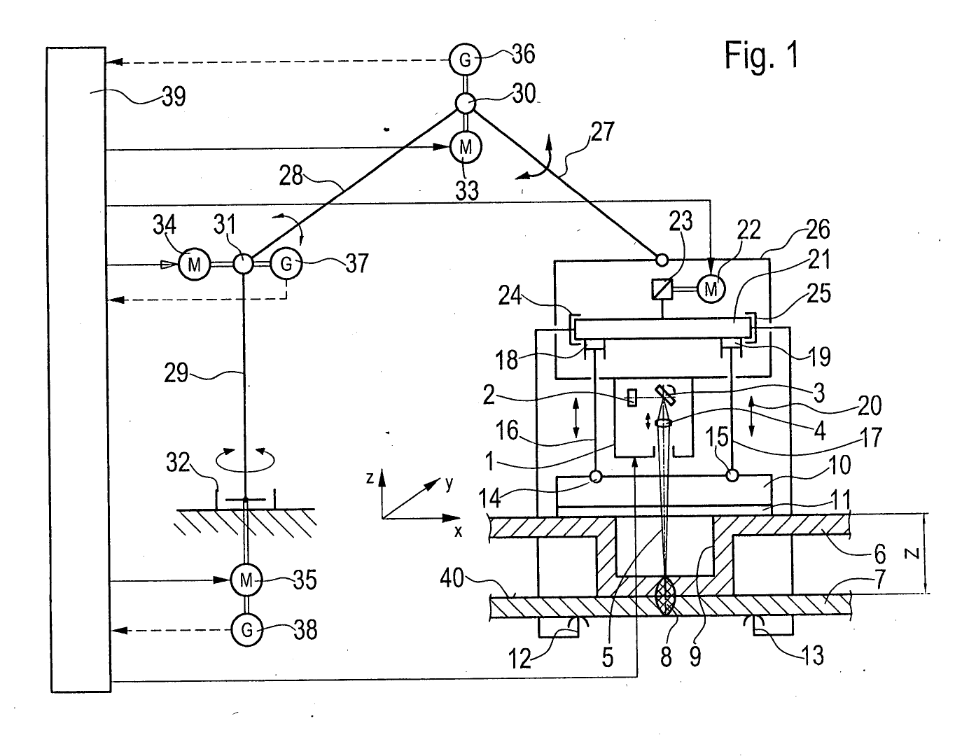

In FIG. 1 a laser welding device is shown. The laser welding device includes a laser head 1 with a laser light source 2, a movable deflection mirror 3 and a focus system 4. The focused laser beams 5 are directed onto the automobile body parts 6, 7 which are held together by a clamping device. The thermal effect of the laser beams 5 produces a welding seam 8, which joins the parts 6, 7. The automobile body part 6 includes a U-shaped reinforcing corrugation 9 and lies flat against the automobile body part 7. At the reinforcing corrugation 9 a height offset z exists between the automobile body parts 6, 7. The clamping device is comprised among other things of a pressure element 10, which bridges over reinforcing corrugation 9, perpendicular to longitudinal direction thereof, and acts on the upper side of the automobile body part 6. The contact surface of the pressure element 10 has a high friction effect on the upper side of the automobile body part 6 due to a coating 11. Alternatively to the coating 11, the contact surface can be roughened mechanically or be unmodified. Below the automobile body part 7 there are located counter-holders 12, 13. The pressure element 10 is connected via linkages 14, 15 and rods 16, 17 with actuators 18, 19, which make possible a clamping and unclamping movement of the pressure element 10 in the vertical direction 20. The actuators 18, 19 are in a connector 21, which is movable by means of a motor 22 and a drive 23 in guides 24, 25 on the coupling box 26 of a robot arm 27. Therewith the clamping device is positionable independently of the laser head 1. Besides the robot arm 27, the robot includes a further arm 28 and a column 29, which are connected to each other via rotation linkages 30-32. In each rotation linkage 30-32 there is a motor 33-35 and a rotary encoder 36-38. For controlling the movement of the columns 29, the arms 27, 28 of the pressure element 10, the deflection mirror 3 and the focus system 4 the motors 22, 33-35 and the position drives of the deflection mirror 3 and the focus system 4 are connected with a control device 39. Likewise, the laser head 1 is in communication with the control device 39 for activation of the laser light source 1.

The laser head 1 can include a scanner system for deflection of the laser beam 5 in a work plane 40. For this, the deflection mirror 3 is pivotable in two axes perpendicular to each other by two separately controllable motors. The focus system 4 includes at least one lens, which is displaceable in a guide with a motor in the direction of the optical axis of the laser beams 5.

From the signals of the rotary encoders 36-38 the angular positions of the columns 29 and the arms 27, 28 are produced in a base coordinate system x, y, z. By means of a computer and a program in the control device 39 the position of the focus point of the laser beams 5 on the part 6 and the position of the press element 10 are calculated, controlled and in certain cases corrected. Therein it is taken into consideration that the clamping position is maintained for a short time during the movement of the coupling box 26. The clamping device is located during this time in a relatively quiet condition or position relative to the locationally fixed automobile body parts 6, 7.

The clamping forces are transmitted via the pressure element 10 and the automobile body part 6 onto the body part 7. Therewith the automobile body part 6, 7 are positioned precisely relative to each other and fixed. The pressure element 10 has a simple geometry, which makes possible the passage through of the laser beams 5.

The application of the invention is not limited to the above-described laser welding process. The inventive process functions of course in simple processing devices without scanner and without computing the position of a workpiece.

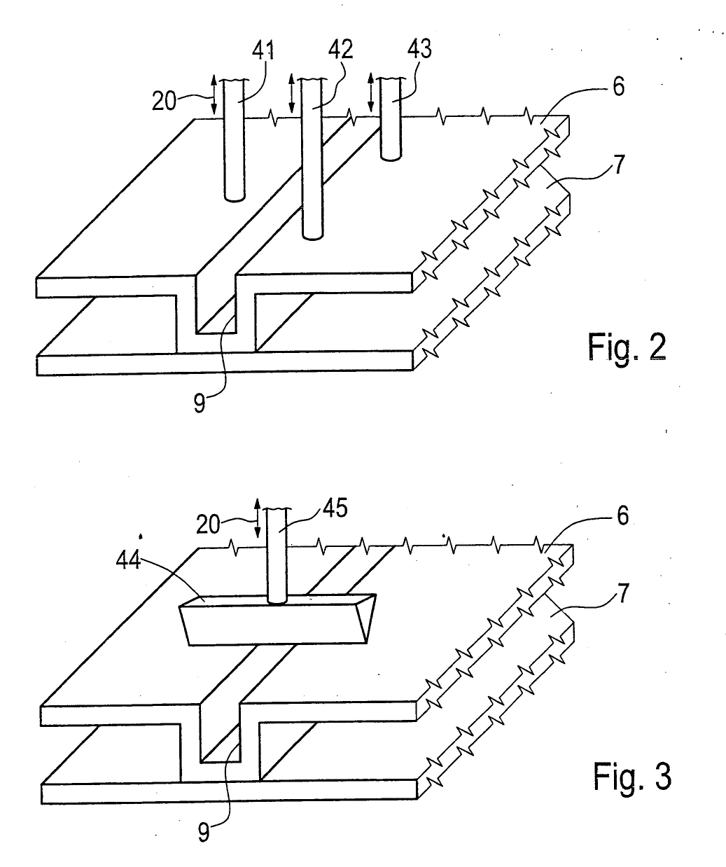

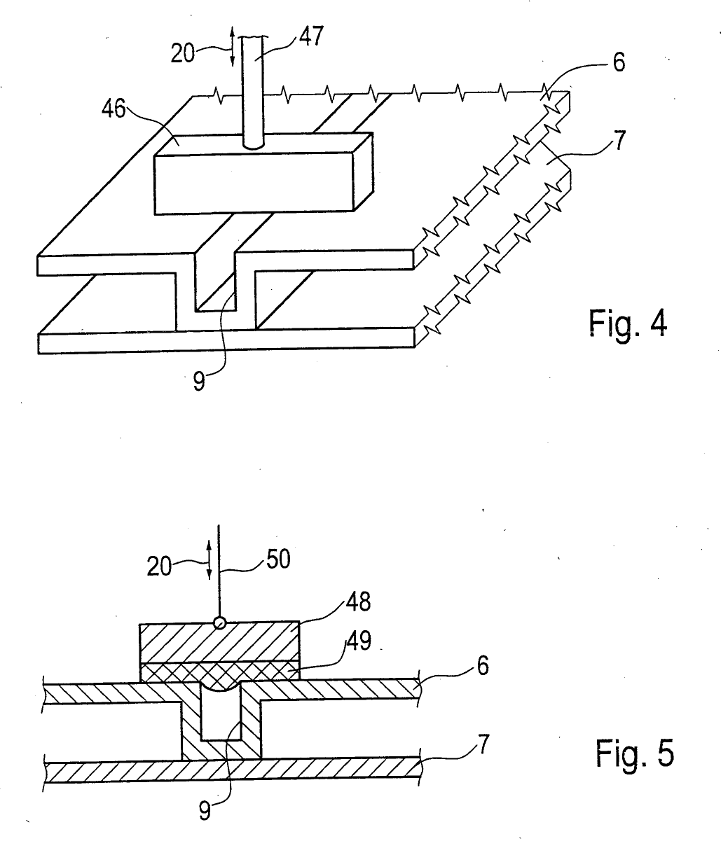

In FIGS. 2-5 various possibilities of the clamping force input to the automobile body part 6 are shown. In FIG. 2 there is shown a clamping force input using three stamps 41-43. These stamps 41-43 are individually or separately movable in the vertical direction 20. This nearly point-shaped clamping force input using the stamps 41-43 requires little construction space, so that with the laser head 1 a further processing area in the longitudinal direction of the reinforcing corrugation 9 can be followed, without it being necessary to relocate the stamps 41-43. FIG. 3 shows an essentially linear shaped clamping force input with a cutter shaped pressure element 44. The pressure element 44 is seated on the upper side of the automobile body part 6 transverse to the longitudinal direction of the reinforcing corrugation 9. The force input occurs with a central, articulated-mounted bolt 45 in the vertical direction 20. As in FIG. 1, FIG. 4 shows an example with planar force input with a pressure element 46 with rectangular shaped contact surface on the upper side of the automobile body part 6. The force input occurs likewise via a central, articulated mounted bolt 47. FIG. 5 shows a pressure element 48 with a yielding elastic contact surface 49. Upon force input via a rod 50, connected articulated with the pressure element 48, the elastic material is pressed together with the contact surface or layer 49, while in the area of the reinforcing corrugation 9 the material remains substantially unchanged. Thereby the automobile body part 6 obtains a certain securing or holding against sideways movement. The elastic contact surface 49 brings about a gentle clamping of the automobile body parts 6, 7, whereby no clamping marks are produced in the upper side of the automobile body part 6.

The clamping elements shown in FIGS. 2-5 can be provided in multiple, preferably in a connected, parallel arrangement. The possibility of the positioning of the clamping elements improves itself further when these are made of a material which is transmissive to laser beams 5. In this case the clamping elements can be positioned almost without limitation.

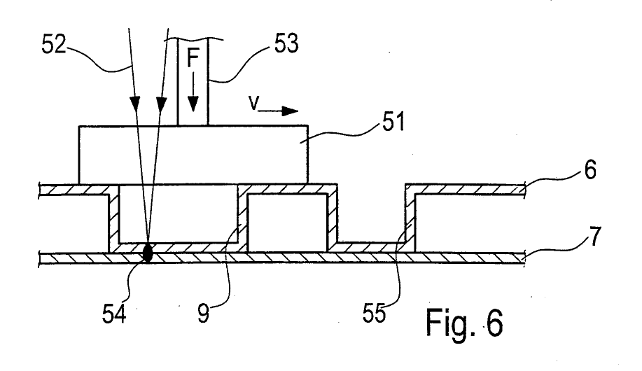

FIG. 6 shows a use of a clamping element 51 in a laser welding device for joining two workpieces 6, 7. During welding with laser beams 52 a force F is exercised via a stamp 53 on the upper lying workpiece 6 so that at a welding site 54 in the base of a reinforcing corrugation 9 the workpieces 6, 7 lie closely adjacent to each other. During welding the clamping element 51 bridges over the reinforcing corrugation 9 transverse to its longitudinal orientation. The laser beams 52 are positionable in the base of the reinforcing corrugation 9 independent of the clamping element 51. For transferring the clamping element 51 over an adjacent reinforcing corrugation 55 the clamp element 51 is movable with a speed v transverse to the longitudinal direction of the reinforcing corrugations 9, 55. The positioning of the clamping element 51 in the direction of the speed vector v occurs by a force input with a sliding movement upon the workpiece 6, whereby the clamping element 51 is comprised of a sliding material. Further, the positioning can occur with a drive means, which can occur for example using a friction driven chain or a motor driven contact unit of the clamping element 51.

### LIST OF REFERENCE NUMBERS

1 laser head
2 laser light source
3 deflection mirror
4 focus system
5 laser beam
6, 7 automobile body part
8 welding seam
9 reinforcing corrugation
10 pressure element
11 coating
12, 13 opposing holders
14, 15 linkage
16, 17 rod
18, 19 actuator
20 direction
21 connector
22 motor
23 drive
24, 25 guide
26 coupling box
27 robot arm
28 arm
29 column
30-32 rotation linkage
33-35 motor
36-38 rotary encoder
39 control device
40 working plane
41-43 stamp
44 pressure element
45 bolt
46 pressure element
47 bolt
48 pressure element
49 contact layer
50 rod
51 clamping element
52 laser beam
53 stamp
54 welding site
55 reinforcing corrugation

1-11. (canceled)

12. A device for processing workpieces with an elevated offset, comprising:
a processing head having a tool secured thereto, which tool is directed towards a work area of at least one workpiece,
a clamping head with a clamping tool for fixing the workpiece at a desired position in the environment of the work area, and
an actuating element for the clamping tool,
wherein the clamping tool (10) is adapted to the height offset (z).

13. The device according to claim 12, wherein in the case of a workpiece (6) with a corrugation (9) the clamping device (10) is designed to bridge over the corrugation (9).

14. The device according to claim 12, wherein the clamping tool (41-44, 46) can be applied with point or linear shaped or planar contact against a surface of a workpiece (6) lying on essentially the same plane.

15. The device according to claim 12, wherein in the workpieces (6, 7) to be joined the joining position of the work head (1) and the contact position of the clamping tool (10) lie height offset relative to each other.

16. The device according to claim 15, wherein the contact position is adjustable relative to the joining position.

17. The device according to claim 12, wherein the clamping tool (10) includes an element which compensates for a height differential (z) existing on a workpiece (6).

18. The device according to claim 17, wherein the balancing or compensating element is provided with at least one movably mounted clamping element (10).

19. The device according to claim 17, wherein the balancing or compensating element is provided with at least one elastic, yieldable pressure element (48, 49).

20. The device according to claim 17, wherein the clamping force of the clamping tool (10) is adjustable.

21. The device according to claim 17, wherein the clamping tool includes mechanical or pressure operated actuating elements.

22. The device according to claim 13, wherein clamping tool includes at least one clamping element (51) movable over the upper surface of a workpiece (6) and bridging over the corrugation (9, 55).

23. A device for processing at least one workpiece having a corrugation defined by an upper surface, a corrugation floor, and sidewalls between said floor and said upper surface, said device comprising:
a processing head having a tool secured thereto, which tool is directed towards a work area,
a clamping head with a clamping tool for applying pressure against said upper surface of said workpiece, and
an actuating element for the clamping tool,
wherein the clamping tool (10) is adapted to contact and bridge over said corrugation upper surface, and
wherein said work area is in the floor of said corrugation.

24. The device according to claim 23, wherein said tool is a laser beam welding tool, an electron beam welding tool or a plasma welding tool.

25. A method for joining two workpieces, at least one of said workpieces having an elevated parallel offset, said method comprising:
placing two workpieces between the clamping elements of a clamping device, one of the clamping elements being a clamping head with a clamping tool moveable relative to the clamping head via an actuating element,
moving said clamping tool towards said workpieces such that said clamping tool bears against the elevated parallel offset of the workpiece having the elevated parallel offset, whereby said two workpieces are brought into close contact in an area to be joined, and
using a joining device to join said two workpieces in said area to be joined,
wherein the surface of the workpiece having the elevated parallel offset is on a different plane from the plane of the area to be joined, and
wherein said clamping tool is adjustable to the plane of the elevated parallel offset while the joining device is in position to join said workpieces.
